(19) United States
(12) Patent Application Publication
(10) Pub. No.: US 2026/0197091 A1
(43) Pub. Date: Jul. 9, 2026

(54) HOMODYNE BIDIRECTIONAL OPTICAL TRANSCEIVER

(71) Applicant: Lucidean, Inc., Goleta, CA (US)

(72) Inventors: Christopher R. COLE, Goleta, CA (US); Aaron MAHARRY, Goleta, CA (US); Hector A. ANDRADE PAEZ, Goleta, CA (US); Clint Lee SCHOW, Goleta, CA (US); Larry Allen COLDREN, Goleta, CA (US)

(21) Appl. No.: 19/133,955

(22) PCT Filed: Dec. 4, 2023
(86) PCT No.: PCT/US2023/082310

§ 371 Date: May 29, 2025

Related U.S. Application Data
(60) Provisional application No. 63/430,083, filed on Dec. 5, 2022.

(51) Int. Cl. H04B 10/63; H04B 10/43

(52) U.S. Cl. CPC H04B 10/63; H04B 10/43

(57) ABSTRACT

An optical communication system includes optical transceivers coupled by one or more fiber cables and performs remote, hybrid, or local modulation of light signals to encode data for transmission between the transceivers. Remote modulation entails generation of a light signal at each of the transceivers and modulation of at least a portion of that light signal at the other transceiver. Hybrid modulation entails generation of a light signal at one of the transceivers, modulation of at a portion of that light signal at the same transceiver, and modulation of another portion of that light signal at the other transceiver. One or more amplifiers may be used at one or both transceivers. Indicators, such as LEDs, may be used to monitor for operation at complementary wavelengths when wavelength-division multiplexers are used at the transceivers. One or more controllers control operation of light sources and corresponding control of MZIs.

### BACKGROUND

High capacity and high data rate communication is increasingly demanded by certain applications. In a data center, for example, servers that store and process data may be interconnected to facilitate data transfer between the servers, as well as to the outside world. Optical transceivers coupled to the servers may facilitate that (bidirectional) data transfer over optical cables. At the receiving transceiver, intradyne detection may be used such that the transmitted modulated optical signal (e.g., modulated in phase and/or amplitude) may be mixed with the unmodulated signal (referred to as a local oscillator (LO)) to recover the transmitted data. In a prior approach, the transmitted signal is generated with a different laser than the LO. In this case, the two lasers must be temperature controlled and stabilized to ensure that their wavelengths are close to each other (e.g., on the order of 3 gigaHertz (GHz)).

### SUMMARY

In some embodiments, an optical transceiver is provided for data communication.

According to one or more embodiments, an optical communication system includes a first optical transceiver. The first transceiver includes a receiver, a light source to output a light signal, and a splitter to split the light signal to a first signal and a second signal. The first signal is provided to the receiver as a local oscillator. The optical communication system also includes a second optical transceiver including a transmitter to obtain the second signal from the first optical transceiver and modulate the second signal to generate a modulated signal that is provided to the receiver of the first optical transceiver. The receiver of the first optical transceiver demodulates the modulated signal based on the local oscillator.

Optionally, the first optical transceiver includes a transmitter to modulate an unmodulated signal generated at the second optical transceiver and provided to the first optical transceiver, and the second optical transceiver includes a receiver to demodulate a modulation output of the transmitter of the first optical transceiver that is provided to the second optical transceiver.

Optionally, the first optical transceiver or the second optical transceiver includes one or more amplifiers.

Optionally, the first optical transceiver includes a transmitter and both the transmitter of the first optical transceiver and the transmitter of the second optical transceiver modulate signals generated by the light source of the first optical transceiver.

Optionally, the transmitter implements dual-polarization modulation such that the modulated signal includes a first modulated signal with a first polarization and a second modulated signal with a second polarization.

According to another embodiment, an optical communication system includes a first optical transceiver. The first optical transceiver includes a first receiver, a first transmitter, and a light source configured to output a light signal. The optical communication system also includes a second optical transceiver. The second optical transceiver includes a second receiver, and a second transmitter. Both the first transmitter of the first optical transceiver and the second transmitter of the second optical transceiver modulate signals generated by the light source of the first optical transceiver.

According to yet another embodiment, an optical communication system includes a first optical transceiver. The first optical transceiver includes a first receiver, a first transmitter, a first light source to output a first light signal at a first wavelength, a first fiber optic tap, and a first light emitting diode (LED). The first fiber optic tap siphons a portion of an input signal, received via a fiber cable, at the first optical transceiver. The first LED emits light based on the portion of the input signal having an intensity above or below a threshold value.

According to yet another embodiment, an optical communication system includes a first optical transceiver. The first optical transceiver includes a first light source to emit a light signal at a first wavelength, a second light source to emit a light signal at a second wavelength, and a first controller to control only one of the first light source and the second light source to be operational at a time. The optical communication system also includes a second optical transceiver. The second optical transceiver includes a third light source to emit a light signal at the first wavelength, a fourth light source to emit a light signal at the second wavelength, and a second controller to control only one of the third light source and the fourth light source to be operational at a time. The first controller controls the first light source and the second light source and the second controller controls the third light source and the fourth light source, respectively, such that the first light source and the third light source are not operational at a same time and the second light source and the fourth light source are not operational at a same time.

The foregoing has outlined some of the pertinent features of the disclosed subject matter. These features are merely illustrative.

### BRIEF DESCRIPTION OF THE DRAWINGS

The examples described throughout the present document will be better understood with reference to the following drawings and descriptions. In the figures, like-referenced numerals designate corresponding parts throughout the different views.

FIG. 1 is a block diagram of an exemplary remote modulation optical communication system according to some embodiments;

FIG. 2 is a block diagram of an exemplary remote modulation optical communication system according to some embodiments;

FIG. 3 is a block diagram of an exemplary remote modulation optical communication system according to some embodiments;

FIG. 4 is a block diagram of an exemplary remote modulation optical communication system according to some embodiments;

FIG. 5 is a block diagram of an exemplary remote modulation optical communication system according to some embodiments;

FIG. 6 is a block diagram of an exemplary remote modulation optical communication system according to some embodiments;

FIG. 7 is a block diagram of an exemplary local modulation optical communication system according to some embodiments;

FIG. 8 is a block diagram of an exemplary local modulation optical communication system according to some embodiments;

FIG. 9 is a block diagram of an exemplary local modulation optical communication system according to some embodiments;

FIG. 10 is a block diagram of an exemplary local modulation optical communication system according to some embodiments;

FIG. 11 is a block diagram of an exemplary local modulation optical communication system according to some embodiments;

FIG. 12 is a block diagram of an exemplary local modulation optical communication system according to some embodiments;

FIG. 13 is a block diagram of an exemplary hybrid optical communication system according to some embodiments;

FIG. 14 is a block diagram of aspects of an exemplary hybrid multi-wavelength optical communication system according to some embodiments;

FIG. 15 is a block diagram of aspects of an exemplary hybrid multi-wavelength optical communication system according to some embodiments;

FIG. 16 is a block diagram of an exemplary multi-wavelength optical communication system according to some embodiments;

FIG. 17 is a block diagram of an exemplary multi-wavelength optical communication system according to some embodiments;

FIG. 18 is a block diagram of an exemplary multi-wavelength optical communication system according to some embodiments;

FIG. 19 is a block diagram of an exemplary multi-wavelength optical communication system according to some embodiments;

FIG. 20 is a block diagram of an exemplary multi-wavelength optical communication system according to some embodiments;

FIG. 21 is a block diagram of an exemplary dual-wavelength optical communication system according to some embodiments;

FIG. 22 is a block diagram of an exemplary dual-wavelength optical communication system according to some embodiments; and

FIG. 23 is a block diagram of aspects of a multi-wavelength pair optical communication system according to some embodiments.

### DETAILED DESCRIPTION

Reference will now be made to the drawings to describe the present disclosure in detail. It will be understood that the drawings and exemplified embodiments are not limited to the details thereof. Modifications may be made without departing from the spirit and scope of the disclosed subject matter.

As noted, optical transceivers may be used to transmit and receive data (e.g., in a data center). A laser output may be modulated and transmitted over a fiber cable to the other transceiver, where it is demodulated to recover the data. To avoid the need to stabilize and cool two different lasers that respectively output the modulated signal and the local oscillator signal used in demodulation, a prior approach involves generating the modulated signal and the local oscillator signal at the same transceiver and transmitting both signals, together or separately. At the other transceiver, on the other side of the fiber cable, the receiver can use the received local oscillator signal to perform homodyne detection to demodulate the received modulated signal.

Embodiments detailed herein relate to a transmitter employing a far-end source for remote modulation. That is, the transmitter of one transceiver may modulate (i.e., encode data onto) an optical signal generated by a laser of the other transceiver (connected via an optical cable) that will receive and demodulate the modulated signal to recover the data. Thus, the transmitter that modulates the optical signal is remote, on a far end of the communication link (at the other transceiver), to the source of the optical signal. Such an arrangement provides the advantages of the local oscillator signal and the modulated signal originating from the same laser without having to transmit both the local oscillator signal and the modulated signal. Thus, modulated signals may be transmitted simultaneously from the two transceivers. The receiver, which is at the same transceiver as the originating laser, can use the local oscillator signal that never left the transceiver to demodulate the modulated signal that was transmitted (unmodulated) to the other transceiver and returned (modulated).

According to some embodiments, the remote modulation architecture, as well as the local modulation architecture, may benefit from amplifying the input or output of the transmitter. In some embodiments, a hybrid architecture may be used, with one of the transceivers employing remote modulation while the other transceiver uses local modulation.

Exemplary embodiments may also include multi-wavelength transceivers with remote or local (or hybrid) modulation. When complementary wavelengths are not used by the two transceivers, an indication may be provided to facilitate correction. Generally, the current communication channel that is operational may be indicated. In additional embodiments, the two transceivers may communicate to ensure that complementary wavelengths are used in the transmissions from the two sides.

The dual-polarization homodyne bidirectional optical transceivers according to the various aspects detailed herein facilitate low power data transfer in high capacity, high transfer rate applications.

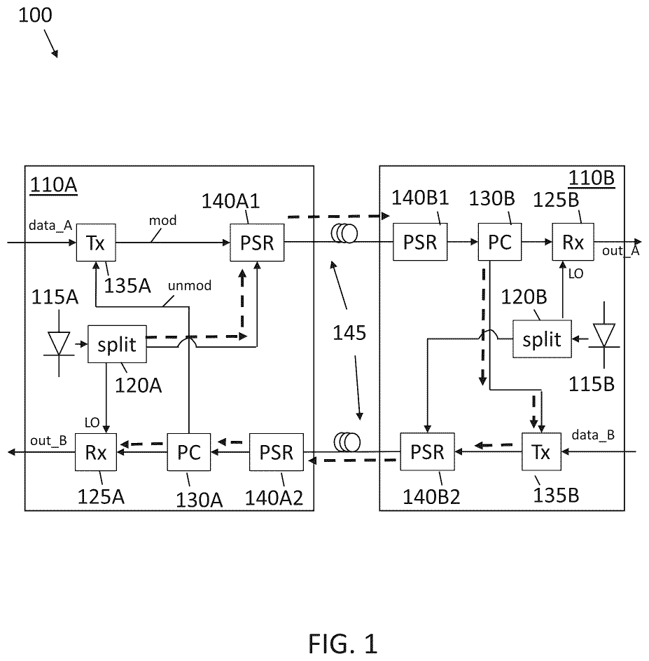

FIG. 1 is a block diagram of an exemplary remote modulation optical communication system 100 according to some embodiments. As shown, two optical transceivers 110A and 110B (generally referred to as 110) communicate with each other over fiber cables 145 (e.g., single mode fiber (SMF)). The optical transceiver 110A may communicate with a server or network switch to obtain data in the form of an electrical signal, indicated as data_A, for transmission to the other transceiver 110B and to provide data in the form of an electrical signal, indicated as out_B, based on an optical signal transmitted from the other transceiver 110B. Similarly, the optical transceiver 110B may communicate with another network switch or server to obtain data, indicated as data_B, for transmission to the server connected to transceiver 110A and to provide data, indicated as out_A, transmitted from the transceiver 110A. Thus, the transceivers 110 facilitate communication and data transfer between the two network switches or servers connected via the transceivers 110 and the fiber cables 145.

Each of the transceivers 110 includes a light source 115A, 115B (generally referred to as 115). The light source 115 may produce light that is split, by a splitter 120A, 120B (generally referred to as 120). The split may be equal or unequal in terms of the power divided among the two outputs of the splitter 120. Each of the transceivers 110 also includes a transmitter 135A, 135B (generally referred to as 135) that encodes data onto a light signal. Specifically, each transmitter 135 obtains an input unmodulated light signal (indicated as “unmod” in transceiver 110A) and data from a server or network switch or other coupled source in the form of an electrical signal (indicated as “data_A” in transceiver 110A). The transmitter 135 modulates the phase and/or amplitude of the unmodulated light signal to encode the data and produce a modulated signal (indicated as “mod” in transceiver 110A). As shown, each of the transceivers 110 additionally includes a receiver 125A, 125B (generally referred to as 125) that demodulates an input modulated signal to recover transmitted data.

The path indicated by the dashed line is detailed to describe remote modulation and other components that are also shown for the exemplary transceivers 110A, 110B in FIG. 1. Specifically, modulation of light generated by the light source 115A of the transceiver 110A at the transmitter 135B of the transceiver 110B is detailed. Light source 115A (e.g., a laser) generates light that is split by splitter 120A into two light beams. One of the light beams output by the splitter 120A is provided to the receiver 125A and acts as a local oscillator (LO). That is, each receiver 125 recovers transmitted data by mixing the unmodulated LO signal with a modulated signal. Additional filtering or processing with a digital signal processor (DSP), either at the transceiver 110 or before or within the outside device (e.g., server or network switch), may also be performed to ultimately obtain the data encoded in the modulated signal.

While one of the light beams output by the splitter 120A is provided to the receiver 125A, the other light beam is provided to a polarization splitter-rotator (PSR) 140A1. Generally, a PSR 140 is a passive, bidirectional device although PSR 140A1 is not used bidirectionally. As shown, inputs to the PSR 140A1 include the light beam from the splitter 120A and also modulated light from the transmitter 135A. This modulated light results from light generated by the light source 115B of the transceiver 110B and is not detailed. At the PSR 140A1, the (unmodulated) light beam from the splitter 120A and the modulated output of the transmitter 135A are combined and rotated. That is, the PSR 140A1 may cause one of the two to have a state of polarization (SOP) that is horizontal and the other of the two to have a SOP that is vertical. The output of the PSR 140A1 is then conveyed to the transceiver 110B over the fiber cable 145. In the fiber cable 145, the SOP of the two signals (unmodulated splitter 120A output and modulated transmitter 135A output) may be rotated.

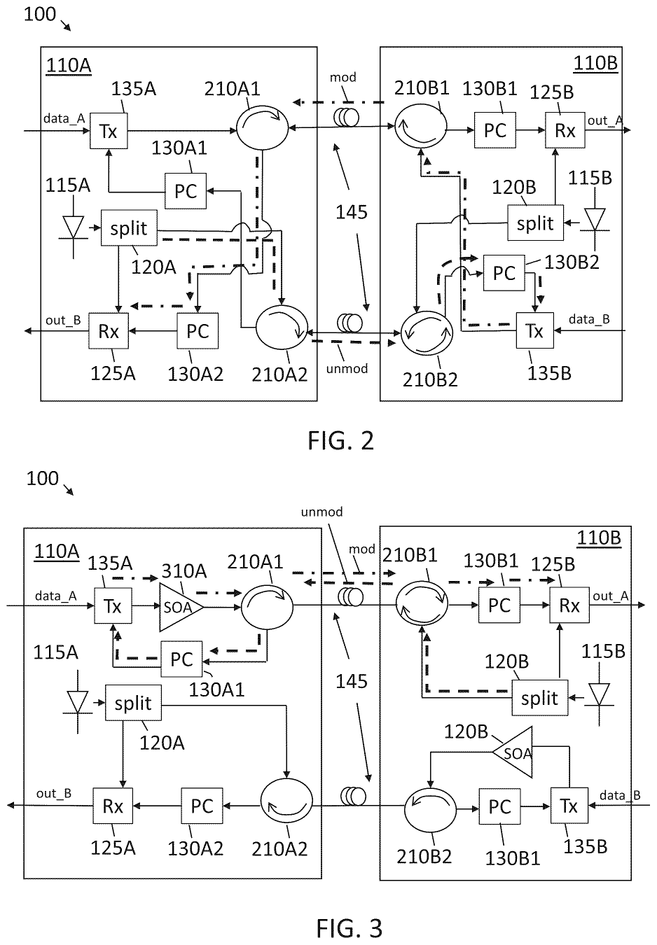

At the transceiver 110B, the PSR 140B1 receives the output of the PSR 140A1. Based on the rotation of SOP in the fiber cable 145, the two signals (unmodulated splitter 120A output and modulated transmitter 135A output), which may have been multiplexed onto horizontal and vertical polarizations by the PSR 140A1, may no longer be easily distinguishable. The PSR 140B1 projects the received signal into horizontal and vertical polarizations, but this may not necessarily separate the two signals. Thus, the output of the PSR 140B1 is provided to a polarization controller (PC) 130B. A PC 130 generally manipulates the projections output by the PSR 140 and performs arbitrary angle rotations to recover the two signals that were transmitted. The exemplary architecture of the transceivers 110 in FIG. 1 facilitates having a single PC 130 at each transceiver 110. However, other exemplary embodiments (e.g., FIG. 2) may require a separate PC 130 for the receiver 120 input and the transmitter 130 input.

The PC 130B provides the modulated transmitter 135A output to the receiver 125B. As the dashed line indicates, the PC 130B provides the unmodulated light beam output by the splitter 120A to the transmitter 135B of the transceiver 110B. Thus, the transmitter 135B of the transceiver 110B (remotely) modulates a light beam that was provided by the light source 115A of the transceiver 110A. The transmitter 135B outputs a modulated signal, modulated to encode the data (data_B) provided by a server or network switch coupled to the transceiver 110B, for example.

The modulated output of the transmitter 135B is provided to the PSR 140B2. A second input to the PSR 140B2 is an output of the splitter 120B. The PSR 140B2 may cause each of the input signals to have a different (e. g, orthogonal) polarization when conveyed over the fiber cable 145. At the transceiver 110A, the PSR 140A2 receives the two signals, whose SOP has been rotated in the fiber cable 145. The PC 130A recovers the modulated and unmodulated signals from the projections of the polarizations output by the PSR 140A2 and provides the unmodulated signal from the splitter 120B to the transmitter 135A and provides the modulated signal, modulated by the transmitter 135B, to the receiver 125A. This arrangement of the PSR 140 preceding the PC 130 may apply in each of the subsequent figures that shows a PC 130, even when a PSR 140 is not explicitly shown. That is, a PSR 140 may be included to separate polarizations to facilitate manipulation of the polarizations by the PC 130.

The receiver 125A mixes the LO, obtained from the splitter 120A and originating at the light source 115A, with the modulated signal, (remotely) modulated by the transmitter 135B but also originating at the light source 115A, to provide output (out_B) to the server or network switch or other device coupled to the transceiver 110A. Because the LO and modulated signal at the receiver 125A both originate at the same light source 115A, the wavelength is the same for both without the need to cool and stabilize two lasers. Further, because the LO never leaves the transceiver 110A but, instead, is provided directly to the receiver 125A, the unmodulated signal, provided for remote modulation at the other transceiver 110B, and the modulated signal, provided to the receiver 125B at the other transceiver 110B, may be conveyed over the fiber cable 145 simultaneously.

Each of the transceivers 110 shown in FIG. 1, as well as in FIGS. 2-23, may be fabricated as a photonic integrated circuit (PIC). In some embodiments, some of the components (e.g., circulators, PSRs, wavelength multiplexers) may not be part of the PIC but may be coupled to and packaged with the PIC. Additionally or alternately, the light sources may be coupled to lasers that are not part of the PIC. Also, multiple PICs may be used together to implement the functionality discussed for the transceivers 110 or standalone optic components (e.g., bulk optic components) may be used in addition to or instead of PICs. The transceivers 110 according to the various embodiments detailed herein may have aspects and components that are similar. The components are referred to by the same labels for simplicity and for explanatory purposes and may serve the same or similar functions in each of the embodiments. Additions such as “A,” “B,” “A1,” “B1,” and the like to the label numbers are used to distinguish components within and among the transceivers 110 but refer to similar functionality. Each of the components may be referred to more generally by their label number. Further, although aspects are discussed with reference to a particular exemplary embodiment for explanatory purposes, many of the aspects may also be used with some or all of the other exemplary embodiments.

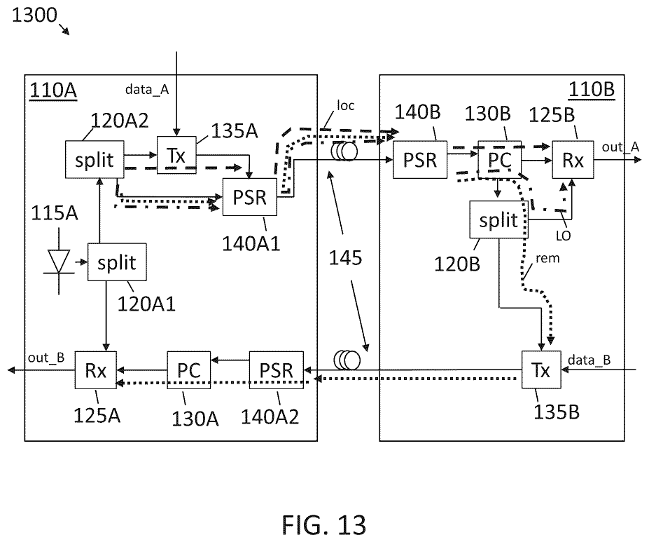

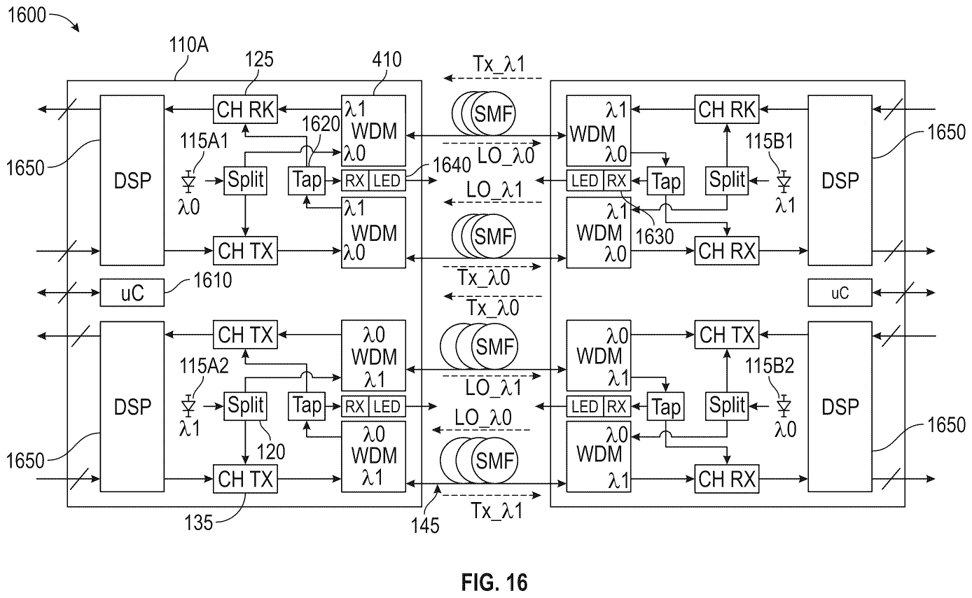

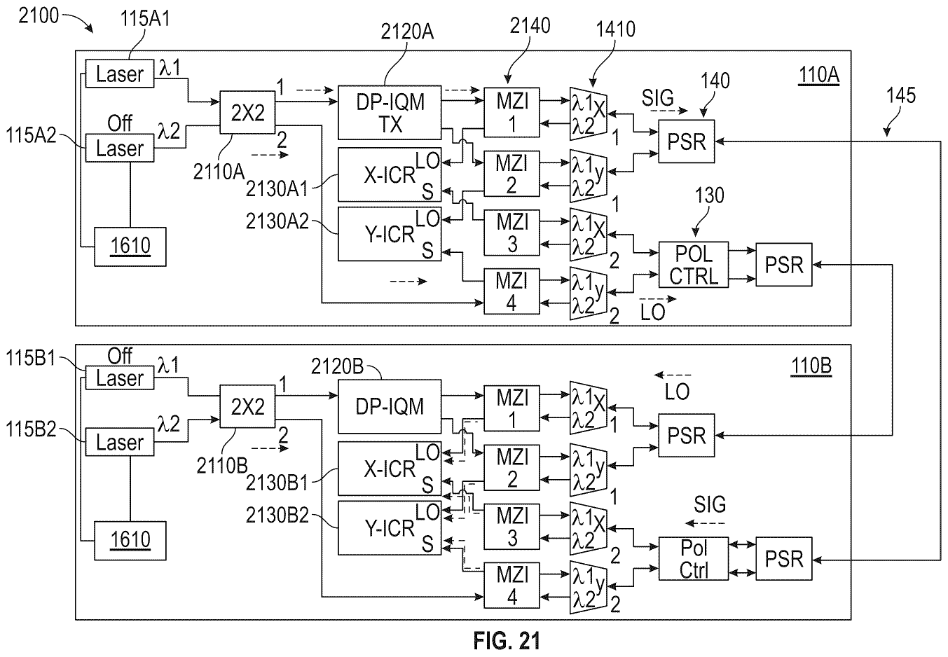

FIGS. 2-6 show additional exemplary embodiments of a remote modulation optical communication system 100, and FIGS. 7-12 show exemplary embodiments of a local modulation optical communication system 700 in which each transceiver 110 generates an LO signal and modulated signal on the same transceiver 110 (i.e., local modulation is implemented by each transceiver 110). FIGS. 13-15 show exemplary embodiments of a hybrid optical communication system 1300 in which one of the two transceivers 110 includes a transmitter that modulates light generated (remotely) at the other transceiver 110 and the other transceiver 110 implements local modulation of light generated at the transceiver 110 such that only one of the two transceivers 110 includes light source(s) 115. FIGS. 16-20 show exemplary embodiments of multi-wavelength optical communication systems 1600, 1800 with an indication of wavelength of operation. FIGS. 21-23 show exemplary embodiments and aspects pertaining to self-organizing transceivers 110 that communicate to select complementary wavelengths. As noted with reference to FIG. 1, each illustration of a PC 130 in the figures may include a preceding PSR 140, even when one is not shown explicitly.

FIG. 2 is a block diagram of an exemplary remote modulation optical communication system 100 according to some embodiments. While the exemplary embodiment of FIG. 1 includes PSRs 140, the exemplary embodiment in FIG. 2 includes circulators 210. As in FIG. 1, dashed lines are used to illustrate the path of a signal that originates at transceiver 110A, is (remotely) modulated at transceiver 110B, and is received and demodulated at transceiver 110A. The dash type is changed before and after modulation for clarity, with solid dashes (labeled “unmod”) indicating the unmodulated signal provided to the transmitter 135B at transceiver 110B and dashes and dots (labeled “mod”) indicating the modulated signal output by the transmitter 135B.

As discussed with reference to FIG. 1, the light source 115A of transceiver 110A provides light that is split by the splitter 120A. One output of the splitter 120A is provided to the receiver 125A as the LO. The other output of the splitter 120A is provided to the circulator 210A2, which directs the (unmodulated) output of the splitter 120A over the fiber cable 145 to the circulator 210B2 of the transceiver 110B. Unlike the arrangement of FIG. 1, the arrangement of FIG. 2 does not result in the (unmodulated) signal to the transmitter 135B and the modulated signal from the transmitter 135A being conveyed to the transceiver 110B together. Thus, circulators 210 that direct an incoming signal rather than separate an incoming signal may be used in the configuration of FIG. 2.

At the transceiver 110B, the circulator 210B2 directs the (unmodulated) output of the splitter 120A to the PC 130B2. The rotation that the polarization of the signal undergoes in the fiber cable 145 may be resolved by the PC 130B2. Thus, the output of the PC 130B2 that is provided to the transmitter 135B for modulation may have a uniform SOP. The modulated signal output by the transmitter 135B, which may use dual-polarization modulation, is routed to the circulator 210B1 and directed over the fiber cable 145 to the circulator 210A1 of the transceiver 110A. The circulator 210A1 directs the incoming modulated signal to the PC 130A2, as shown. As previously noted and as shown in FIG. 1, the PC 130A2 may be preceded by a PSR 140 that is not shown in FIG. 2. Here, the polarization rotation of the signal in the fiber cable 145 may be resolved before the modulated signal is provided to the receiver 125A. The receiver 125A uses the LO (from the splitter 120A) to demodulate the modulated signal and provide an output (out_B). The remote modulation of the signal generated by the light source 115B at transceiver 110B by the transmitter 135A of the transceiver 110A follows a path beginning at the splitter 120B of the transceiver 110B.

FIG. 3 is a block diagram of an exemplary remote modulation optical communication system 100 according to some embodiments. While the arrangement of the components of the transceivers 110 is different in FIG. 3 than in FIG. 2, the exemplary embodiment in FIG. 3 uses circulators 210 like the embodiment in FIG. 2. The exemplary embodiment in FIG. 3 shows an optional amplifier 310 (e.g., semiconductor optical amplifier (SOA)) following modulation by each transmitter 135. As in FIGS. 1 and 2, dashed lines are used to illustrate the path of a signal from a splitter 120 to the receiver 125. In FIG. 3, a signal originating at transceiver 110B is shown. The dash type is changed before and after modulation for clarity, with solid dashes (labeled “unmod”) indicating the unmodulated signal provided to the transmitter 135A at transceiver 110A and dashes and dots (labeled “mod”) indicating the modulated signal output by the transmitter 135A.

Light produced by the light source 115B of the transceiver 110B is split by the splitter 120B. One of the light beams output by the splitter 120B is provided to the receiver 125B as an LO signal used for demodulation. The other light beam output by the splitter 120B is routed to the circulator 210B1. The circulator 210B1 directs the (unmodulated) output of the splitter 120B through the fiber cable 145 to the circulator 210A1 of the transceiver 110A. At the transceiver 110A, the circulator 210A1 directs the unmodulated splitter 120B output to the PC 130A1. The output of the PC 130A1 is provided as an input to the transmitter 135A, which modulates the signal that originated at the light source 115B of the transceiver 110B. The modulated signal output by the transmitter 135A is amplified by the amplifier 310A before being routed to the circulator 210A1. The modulated signal is then conveyed over the fiber cable 145 to the circulator 210B1 to the PC 130B1 and then to the receiver 125B. This receiver 125B uses the LO from the same splitter 120B that gave rise to the modulated signal to obtain output (out_A) based on the data (data_A) sent by the device (e.g., server or network switch) coupled to the transceiver 110A.

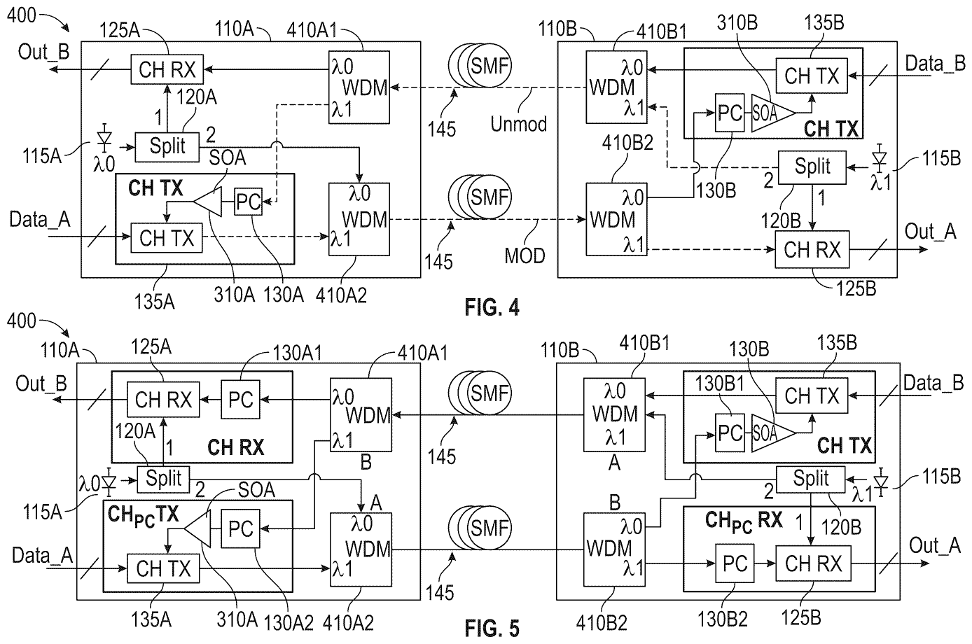

As previously noted, aspects discussed, for explanatory purposes, with reference to one exemplary embodiment may be implemented with other embodiments. For example, the amplifier 310 may be used with the embodiments discussed with reference to FIGS. 1 and 2, as well. Further, the placement of the amplifier 310 discussed with reference to FIGS. 4-12 may be incorporated into any of the embodiments shown in FIGS. 1-3. Similarly, the placement of the amplifier 310 shown in FIG. 3 may be implemented, additionally or alternately, in any of the embodiments shown in FIGS. 4-12.

FIG. 4 is a block diagram of an exemplary remote modulation optical communication system 400 according to some embodiments. Unlike the embodiments of FIGS. 1-3, which include PSRs 140 or circulators 210 for combining and splitting the modulated and unmodulated signals, the embodiments of FIGS. 4-6 include wavelength-divisional multiplexers (WDMs) 410. While WDMs 410 may be less challenging to integrate on a PIC than circulators 210, for example, WDMs 410 may require the two transceivers 110 of the optical communication system 400 to use light sources 115 that output light at different wavelengths (i.e., asymmetric transceivers 110). The WDMs 410 split and combine signals on two wavelength channels (λ0 or λ1). Thus, symmetric transceivers 110 would require bidirectional use of the same channel of the WDMs 410. In addition, while FIG. 3 shows an exemplary arrangement of an amplifier 310 following modulation at a transmitter 135, FIGS. 4-6 illustrate an exemplary placement of an amplifier 310 prior to modulation at a transmitter 135. Neither these exemplary embodiments nor those in FIGS. 7-12, which show another arrangement of amplifiers 310, are intended to limit the numbers and placements of amplifiers 310 in transceivers 110 assembled according to any of the embodiments described herein.

One of the two remote modulation paths is indicated with dashed lines in FIG. 4. The dash type is changed before and after modulation for clarity, with solid dashes (labeled “unmod”) indicating the unmodulated signal provided to the transmitter 135A at transceiver 110A and dashes and dots (labeled “mod”) indicating the modulated signal output by the transmitter 135A. The light source 115B of transceiver 110B outputs light at wavelength λ1 that is split by splitter 120B. One of the light beams output by the splitter 120B is provided to the receiver 125B as the LO signal. The other light beam output by the splitter 120B is directed to the WDM 410B1. The WDM 410B1 conveys the unmodulated signal from the splitter 120B via the fiber cable 145 to the WDM 410A1 of transceiver 110A. The unmodulated signal is then directed to PC 130A where the polarization rotation in the fiber cable 145 is resolved. As previously noted and shown in FIG. 1, a PSR 140 may precede the PC 130.

The output of the PC 130A is then amplified by amplifier 310A before being modulated by transmitter 135A with data (data_A) from a device (e.g., server or network switch) coupled to the transceiver 110A. Operation of the amplifier 310 may be improved by placing the amplifier 310 directly before the transmitter 135. This is because too high a power in the input to the amplifier 310 may saturate the amplifier 310, while too low a power may result in amplification of noise almost as much as signal, resulting in low signal-to-noise ratio (SNR). The power level of the unmodulated signal prior to modulation by the transmitter 135 may be optimal for amplification by the amplifier 310.

The modulated signal output by the transmitter 135A is directed to WDM 410A2, which conveys the modulated signal via fiber cable 145 to the WDM 410B2 of the transceiver 110B. The WDM 410B2 directs the modulated signal to the receiver 125B. At the receiver, the LO, which originates from light source 115B, and the modulated signal, which also originates from light source 115B and is (remotely) modulated by transmitter 135A of transceiver 110A, are mixed to provide the received data output (out_A). In the exemplary embodiment of FIG. 4, an unmodulated signal undergoes polarization correction via a PC 130 (e.g., following a PSR 140) before modulation at the transmitter 135 but a modulated signal does not undergo polarization correction before detection by the dual-polarization coherent receiver 125.

FIG. 5 is a block diagram of an exemplary remote modulation optical communication system 100 according to some embodiments. A difference between the embodiment discussed with reference to FIG. 4 and the embodiment of FIG. 5 is that the modulated signal undergoes polarization correction via a PC 130A1, 130B2 in addition to an unmodulated signal undergoing polarization correction via a PC 130A2, 130B1. As previously noted, the PCs 130 may be preceded by PSRs 140 (not shown). Like the embodiment in FIG. 4, the embodiment in FIG. 5 includes an amplifier 310 at the input of each of the transmitters 135.

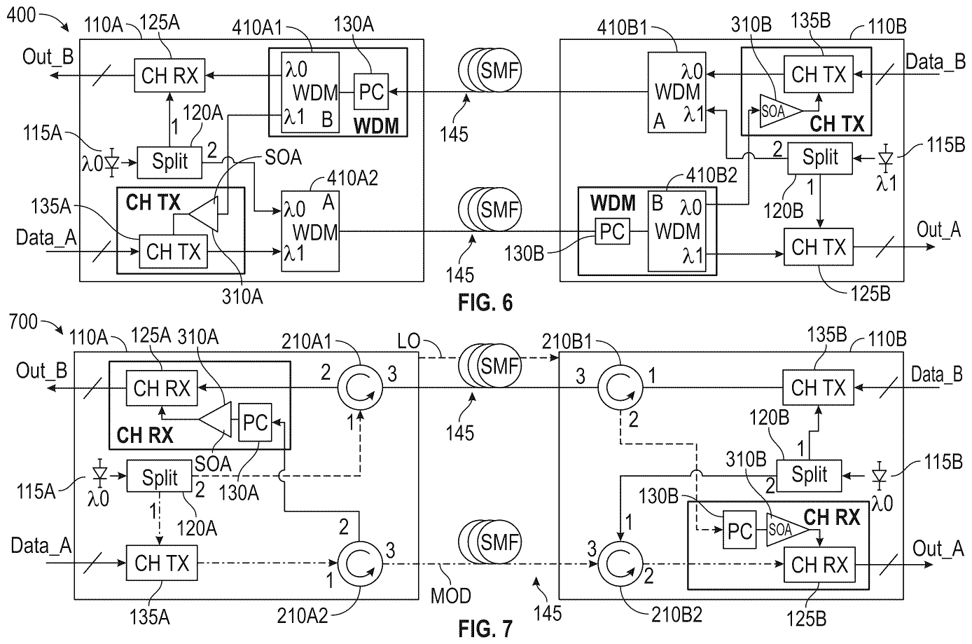

FIG. 6 is a block diagram of an exemplary remote modulation optical communication system 100 according to some embodiments. Like the exemplary embodiments shown in FIGS. 4 and 5, the embodiment of FIG. 6 shows an amplifier 310 at the input to each of the transmitters 135. Unlike the embodiment of FIG. 4, which only includes a PC 130 at the input of the transmitter 135, or the embodiment of FIG. 5, which includes a separate PC 130 for the transmitter 135 and receiver 125, the embodiment of FIG. 6 shows a common PC 130 that performs polarization correction for a signal input via the fiber cable 145 to the transmitter 135 or receiver 125. In this regard, the embodiment of FIG. 6 is similar to the embodiment of FIG. 1.

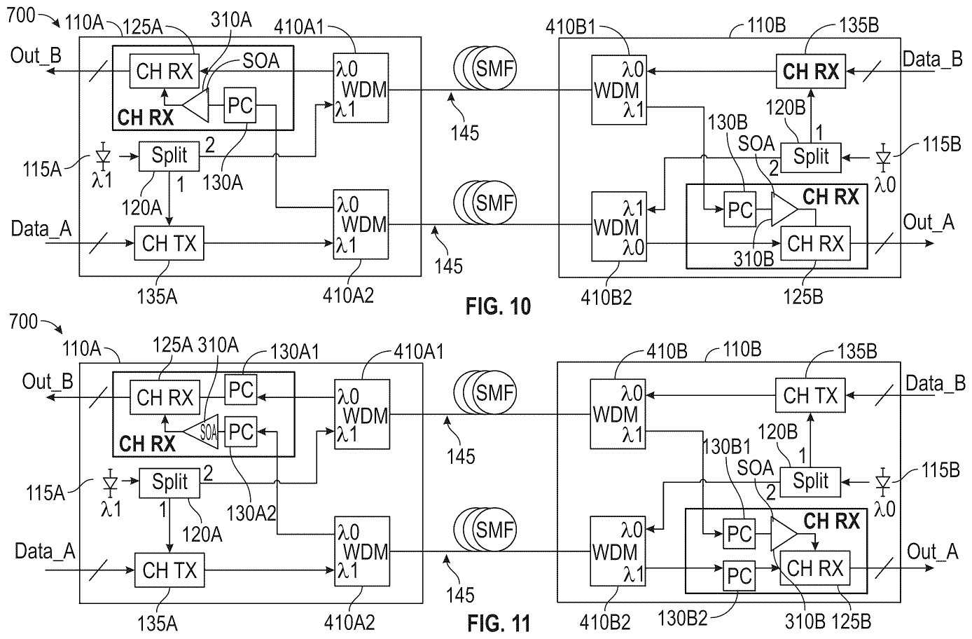

FIGS. 7-9 pertain to single-wavelength local modulation (facilitated by circulators 210), while FIGS. 10-12 pertain to dual-wavelength local modulation (using WDMs 410), with each of the transceivers 110 including a light source 115 emitting light at a different wavelength (i.e., asymmetric transceivers 110). Local modulation refers to the fact that the light source 115 and transmitter 135 that modulates light produced by the light source 115 are part of the same transceiver 110, and both the modulated signal and LO signal are transmitted over fiber cable 145 to the other transceiver 110.

FIGS. 7-12 illustrate amplification prior to demodulation at the receiver 125. In the local modulation optical communication systems 700 of FIGS. 7-12, the unmodulated signal provided to the transmitter 135 is local (i.e., originated at the same transceiver 110 as the transmitter 135). Thus, amplification may not be needed prior to modulation by the transmitter 135. Since the LO signal is transmitted over the fiber cable 145, the optical communication system 700 may benefit from amplification of the LO signal prior to mixing with the modulated signal in the receiver 125. However, as previously noted, the illustrative examples in FIGS. 7-12 (or in FIGS. 3-6) are not intended to limit the placement of amplifiers 310. Amplifiers 310 may be used before or after modulation, in the LO signal path following generation and/or preceding use at a receiver 125, in local or remote systems.

FIG. 7 is a block diagram of an exemplary local modulation optical communication system 700 according to some embodiments. Dashed lines are used to illustrate the signals transmitted by the transceiver 110A to the transceiver 110B. Solid dashes (labeled “LO”) indicate the LO signal while dashes and dots (labeled “mod”) indicate the modulated signal from the transmitter 135A. Light from the light source 115A of the transceiver 110A is split by the splitter 120A into the LO signal, which is provided to the circulator 210A1, and the input to the transmitter 135A. The modulated signal output by the transmitter 135A is provided to the circulator 210A2.

The LO signal is conveyed to the circulator 210B1 via fiber cable 145 and the modulated signal is conveyed to the circulator 210B2 via a different fiber cable 145. The LO signal is directed to a PC 130B and is amplified by an amplifier 310B before being input to the receiver 125B. The modulated signal is directed by the circulator 210B2 to the receiver 125B. At the receiver 125B, the modulated signal is demodulated by mixing it with the LO signal to produce output (out_A).

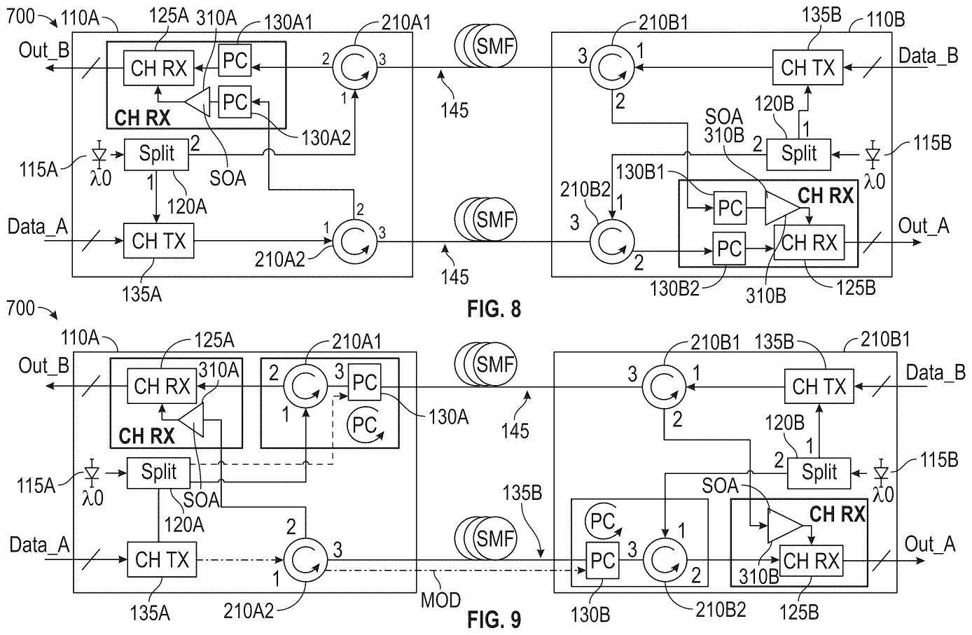

FIG. 8 is a block diagram of an exemplary local modulation optical communication system 700 according to some embodiments. A difference between the embodiment shown in FIG. 7 and the embodiment shown in FIG. 8 is that both the LO signal and the modulated signal undergo polarization correction by a PC 130 prior to being input to a receiver 125 in the embodiment of FIG. 8. In the embodiment of FIG. 7, only the LO signal undergoes polarization correction. As in the embodiment shown in FIG. 7, the embodiment shown in FIG. 8 includes an amplifier for the LO signal prior to its input to a receiver 125.

FIG. 9 is a block diagram of an exemplary local modulation optical communication system 700 according to some embodiments. The embodiment shown in FIG. 9 differs from the embodiments shown in FIGS. 7 and 8 with regard to a position of a PC 130. Specifically, in the embodiment shown in FIG. 9, an LO signal is passed through a PC 130 prior to being conveyed over a fiber cable 145 and a modulated signal is passed through a PC 130 after being conveyed over a fiber cable 145. This is indicated for signals from the transceiver 110A by a dashed line (labeled “LO” for the LO signal) and by dashes and dots (labeled “mod” for the modulated signal). Like the embodiments shown in FIGS. 7 and 8, the embodiment shown in FIG. 9 includes an amplifier 310 to amplify the LO signal prior to input to the receiver 125.

FIGS. 10-12 show embodiments that have similarities to embodiments shown in FIGS. 7-9, respectively, but pertain to a dual-wavelength local modulation optical communication system 700. Thus, the embodiments of FIGS. 10-12 include a WDM 410 rather than a circulator 210.

FIG. 10 is a block diagram of an exemplary local modulation optical communication system 700 according to some embodiments. Similar to the single-wavelength system shown in FIG. 7, the dual-wavelength embodiment of FIG. 10 includes a PC 130 only in the path of the LO signal. The LO signal is also amplified by the amplifier 310 prior to being input to the receiver 125 at each transceiver 110.

FIG. 11 is a block diagram of an exemplary local modulation optical communication system 700 according to some embodiments. Similar to the single-wavelength system shown in FIG. 8, the dual-wavelength embodiment of FIG. 11 includes a PC 130 in the path of the LO signal and a PC 130 in the path of the modulated signal prior to input to the receiver 125 of each transceiver 110. The LO signal is amplified by the amplifier 310 prior to being input the receiver 125 at each transceiver 110, as well.

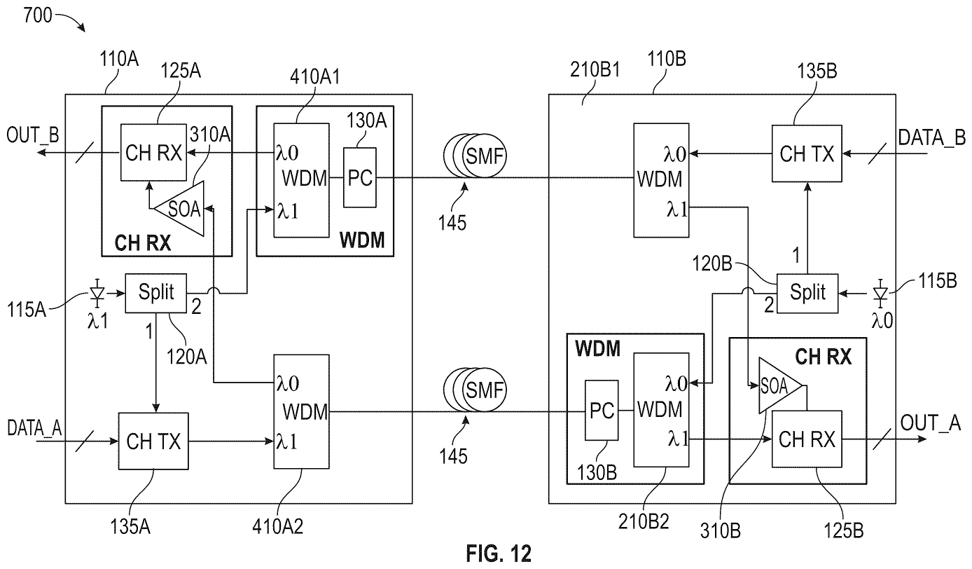

FIG. 12 is a block diagram of an exemplary local modulation optical communication system 700 according to some embodiments. Similar to the single-wavelength system shown in FIG. 9, the dual-wavelength embodiment of FIG. 12 includes a PC 130 for the LO signal prior to transmission in the fiber cable 145 and a PC 130 for the modulated signal following transmission in a different fiber cable 145. As in all of the embodiments of FIGS. 7-11, the embodiment of FIG. 12 includes an amplifier 310 to amplify the LO signal prior to input to the receiver 125 of each transceiver 110.

FIG. 13 is a block diagram of an exemplary hybrid optical communication system 1300 according to some embodiments. The embodiment in FIG. 13 is referred to as a hybrid because it includes both remote modulation of light produced by the light source 115A of transceiver 110A by the transmitter 135B of transceiver 110B and local modulation of light produced by the light source 115A of transceiver 110A by the transmitter 135A of transceiver 110A. According to the hybrid architecture, only one of the transceivers 110, transceiver 110A in the exemplary embodiment of FIG. 13, may include a light source 115.

Despite this difference, like the previously discussed local and remote modulation embodiments, the hybrid modulation embodiment also includes bidirectional communication and modulation/demodulation at each transceiver 110. The fact that only one of the transceivers 110 of a hybrid system may include a light source 115 results in an asymmetry in the components of the transceivers 110 that differs from the wavelength asymmetry discussed, for example, with reference to the exemplary embodiments of FIGS. 4-6 and 10-12.

The transceiver 110A includes two splitters 120A1 and 120A2. The splitter 120A1 splits the light generated by the light source 115A into an LO signal provided to the receiver 125A and a light beam provided to the second splitter 120A2. The second splitter 120A2 provides the LO signal for the receiver 125B of the transceiver 110B, as well as the input signal for modulation by both transmitters 135A and 135B. A dotted line (labeled “rem”) is used to indicate the remote modulation path from the second splitter 120A2. A dashed line (labeled “loc”) indicates the path of the (local) modulated signal that is generated by the transmitter 135A of the transceiver 110A, and dashes and dots (labeled “LO”) indicate the LO signal provided to the receiver 125B.

The PSR 140A1 receives the modulated signal via the transmitter 135A and the unmodulated signal from the splitter 120A2. Although shown as two signals (dotted line “rem” and dashes and dots “LO”), a single unmodulated signal is output from the splitter 120A2 to the PSR 140A1 and is used as both the LO signal at the receiver 125B and for remote modulation by the transmitter 135B. The PSR 140A1 changes the polarization of one of the two inputs such that the signals are conveyed through the fiber cable 145 with different polarizations (e.g., modulated signal from transmitter 135A has horizontal polarization, unmodulated signal has vertical polarization). The signals may undergo rotation of their SOP in the fiber cable 145.

At the PSR 140B of the transceiver 110B, an initial separation of the polarizations is performed. The PC 130B then manipulates the separated polarization components and recovers the two original signals. The modulated signal, which is modulated by the transmitter 135A of the transceiver 110A, is provided to the receiver 125B. The unmodulated signal is routed to a splitter 120B, which splits the unmodulated signal and provides an LO signal to the receiver 125B and provides an input to the transmitter 135B. The remotely modulated signal, which is modulated by transmitter 135B, is conveyed through another fiber cable 145 back to the transceiver 110A. The transmitter 135B may perform dual polarization modulation such that the output is in two parts with different polarizations. At the transceiver 110A, the two parts may be resolved via the PSR 140A2 and PC 130A and provided to the receiver 125A.

The hybrid architecture illustrated in FIG. 13, for example, facilitates cost and complexity savings by requiring only one light source 115 for both transceivers 110 or, put another way, only one transceiver 110 with one or more light sources 115. Generally, the light source 115 may be one of the components of a transceiver 110 that is more vulnerable to failure. In addition, the light source 115 may be more temperature sensitive than other components. Thus, by omitting the need for a light source 115 at one of the transceivers 110 (e.g., transceiver 110B in FIG. 13), the hybrid architecture facilitates optical communication that may be more reliable and tolerant to the environment at one end. The transceiver 110 that does not require a light source 115 may also require less power and dissipate less heat, reducing the cooling needed at one end of the bidirectional communication. These characteristics may make the transceiver 110 without a light source 115 more suitable to be co-packaged with or reside in a server or switch chips. Other exemplary applications that may benefit from a hybrid architecture include telecommunication networks (e.g., access networks, passive optical networks).

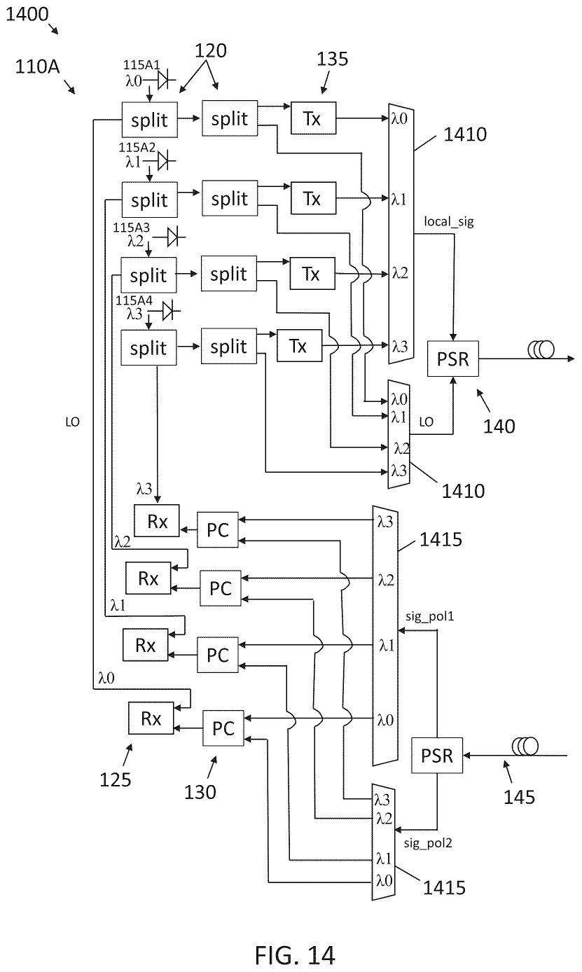

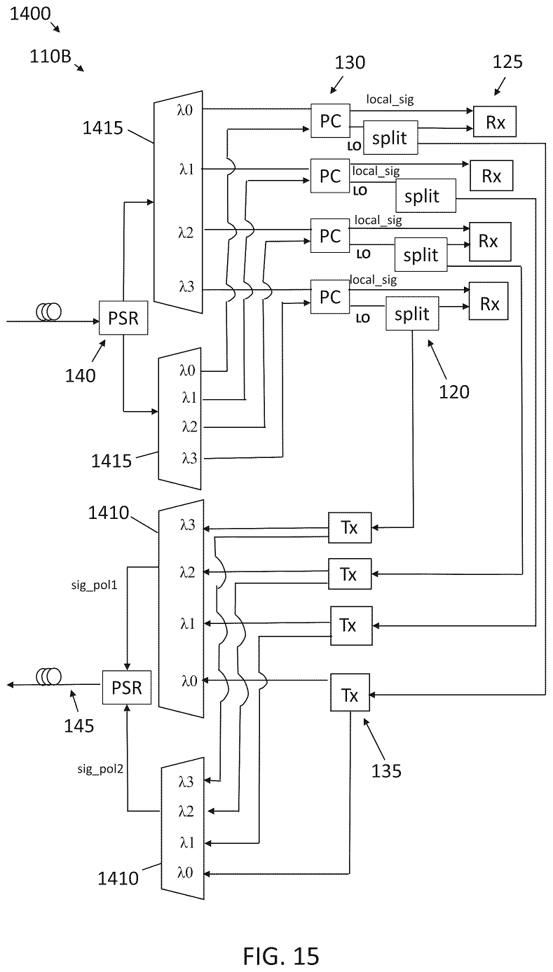

FIGS. 14 and 15 illustrate aspects of exemplary hybrid embodiments extended to a multi-wavelength system. Every instance of the same component is not labeled in the figures for readability. In addition, previously detailed aspects of the functionality of the components are not repeated.

FIG. 14 is a block diagram of aspects of an exemplary hybrid multi-wavelength optical communication system 1400 according to some embodiments. Specifically, FIG. 14 shows a transceiver 110A of the hybrid optical communication system 1400 that includes the light sources 115. The exemplary multi-wavelength transceiver 110A includes four light sources 115A1-115A4 associated with wavelengths λ0-λ3, respectively. As discussed with reference to FIG. 13, in a hybrid system, one of the transceivers 110 provides a locally modulated signal, as well as a light beam for remote modulation.

In the exemplary hybrid optical communication system 1400, transceiver 110A provides a locally modulated signal (indicated as local_sig) at each of the wavelengths λ0-λ3 output by an associated transmitter 135 of the transceiver 110A. As discussed with reference to previous figures, the modulation may encode information obtained from a device (e.g., server or network switch) coupled to the transceiver 110A. Transceiver 110A also provides an LO signal (indicated as LO) at each of the wavelengths to facilitate demodulation at another transceiver 110B (FIG. 15) that receives the locally modulated signals and LO signals. Multiplexers 1410 and demultiplexers 1415 are respectively used to combine and split signals based on the wavelengths, as indicated. As shown, a PSR 140 rotates the polarization of one of the two signals (local_sig, LO) so that they can be directed through the same fiber cable 145.

At transceiver 110A, the LO signal at each of the wavelengths is additionally provided to a corresponding receiver 125 of the transceiver 110A via a splitter 120. At each receiver 125, the LO signal may be mixed with a signal that is (remotely) modulated at the other transceiver 110B. Each receiver 125 may provide the demodulated signal to a device coupled to the transceiver 110A, as discussed with reference to previous figures. The remote modulation may be dual polarization modulation, as discussed with reference to FIG. 15. Thus, according to an exemplary embodiment, the remote modulation may result in two modulated signals with different states of polarization that are conveyed together through a fiber cable 145. As shown, for each of the wavelengths λ0-λ3, the remotely modulated signals may be separated into the two signals with different polarizations (indicated as sig_pol1 and sig_pol2) by a PSR 140 of the transceiver 110A and may undergo polarization correction at PC 130 prior to demodulation at an associated receiver 125 of transceiver 110A.

FIG. 15 is a block diagram of aspects of an exemplary hybrid multi-wavelength optical communication system 1400 according to some embodiments. Specifically, FIG. 15 shows an exemplary transceiver 110B of the hybrid optical communication system 1400 that does not include any light sources 115. Each transmitter 135 of the transceiver 110B performs (remote) modulation of a light beam generated at a corresponding wavelength and conveyed from transceiver 110A, and each receiver 125 of the transceiver 110B demodulates a (locally) modulated signal generated at a corresponding wavelength and conveyed from the transceiver 110A. As discussed with reference to FIG. 14, each unmodulated light beam that is conveyed to the transceiver 110B for (remote) modulation by a transmitter 135 and also for use as an LO signal at each receiver 125 is indicated as LO, and each locally modulated signal conveyed to the transceiver 110B for demodulation at a receiver 125 is indicated as local_sig.

As FIG. 15 indicates, a PSR 140 performs an initial separation of the incoming polarizations and multiplexers 1410 route the signals based on wavelength. Both signals (local_sig and LO) are recovered after undergoing polarization correction at a PC 130, as shown. The locally modulated signal (local_sig) is provided to the receiver 125. The unmodulated signal (LO) is split by a splitter 120 and provided to the receiver 125 to be used for demodulation of the locally modulated signal and also to a transmitter 135 for (remote) modulation. As discussed with reference to previous figures, the receiver output may be provided to a device (e.g., server or network switch) that is coupled to the transceiver 110B.

Each transmitter 135 of the transceiver 110B may modulate the unmodulated signal of a respective wavelength with information provided by a device (e.g., server or network switch) coupled to the transceiver 110B, as discussed with reference to previous figures. Dual polarization modulation may be performed, according to some embodiments, such that some of the output data is output with one polarization and the remainder of the output data is output with another polarization. The two polarizations may be orthogonal, for example. This scheme may facilitate an increase in the information that may be encoded and sent to the transceiver 110A, as compared with the transmitters 135 outputting a single-polarization signal. As shown, each of the two signals output by each of the transmitters 135 (indicated as sig_pol1 and sig_pol2) may be routed to a different multiplexer 1410 that combines the signals based on wavelength. A PSR 140 may combine the signals with different, separable polarizations and direct its output through a fiber cable 145 to the transceiver 110A.

While dual polarization modulation is indicated for the exemplary hybrid multi-wavelength optical communication system 1400 of FIGS. 14 and 15, the transmitters 135 of the transceiver 110B may each provide a modulated signal at the respective wavelength with a single polarization. In this case, the PSR 140 and the second multiplexer 1410 (for sig_pol2) at the output of the transmitters 135 of transceiver 110B and at the input of the receivers 125 of transceiver 110A may be omitted. Similarly, in other exemplary embodiments (e.g., FIG. 13), the transmitter 135 may not implement dual polarization modulation according to some embodiments. Conversely, the exemplary embodiments shown and discussed without dual-polarization modulation may alternately implement dual-polarization modulation.

FIG. 16 is a block diagram of an exemplary multi-wavelength optical communication system 1600 according to some embodiments. Each instance of a component is not labeled for readability. The exemplary transceivers 110 in FIG. 16 include digital signal processors 1650 between each transmitter 135 and receiver 125 pair and the transceiver input/output. The DSPs 1650 may further process the output of each receiver 125, for example. The DSPs 1650 shown in FIG. 16 are optional and may be omitted in the exemplary embodiments in which they are shown. Conversely, DSPs 1650 may be included in any of the other exemplary embodiments shown without DSPs 1650. Each transceiver 110 is also shown to include a microprocessor 1610.

The exemplary optical communication system 1600 in FIG. 16 performs local modulation, as indicated by the fact that each splitter 120 coupled to each light source 115 provides one light beam to a WDM 410 to be sent to the other transceiver 110 as an LO signal and provides the other light beam to a transmitter 135 of the same transceiver 110 as the light source 115. Following modulation at the transmitter 135, the modulated signal is provided to another WDM 410 to also be sent to the other transceiver 110. As indicated, the two light sources 115A1, 115A2 of transceiver 110A operate at two different wavelengths, λ0 and λ1, respectively, and the two light sources 115B1 and 115B2 of transceiver 110B operate at the two wavelengths, λ1 and λ0, respectively.

The dashed lines between the transceivers 110 identify the signals that are conveyed through each of the four fiber cables 145. As indicated, an unmodulated LO signal at one of the two wavelengths and a modulated signal at the other of the two wavelengths may be transmitted in opposite directions over a given fiber cable 145 at a given time. Because the LO signal and modulated signal are not at the same wavelength in any fiber cable 145, the signals in the fiber cable 145 do not interfere with each other. However, a mismatch in the transceiver pairing may result in poor performance of the exemplary multi-wavelength optical communication system 1600. That is, if the light source 115B1 operated at a wavelength of λ0, for example, then proper routing of the bidirectionally transmitted modulated and unmodulated signals (at the same wavelength) would not be possible.

To ensure that the wavelengths are complementary (e.g., λ0 and λ1 rather than λ0 and λ0 or λ1 and λ1 over the same fiber cable 145), a light emitting diode (LED) 1640 may be used as an indicator. In the exemplary arrangement of FIG. 16, one LED 1640 is associated with each transmitter 135 and receiver 125 pair (for each light source 115). The transceivers 110 in the exemplary embodiment include a fiber optic tap 1620 at the output of each WDM 410 that is associated with an LO signal. For example, the tap 1620 associated with the light source 115A1 is at the output of the WDM 410 that provides the LO signal at the wavelength λ1. The four taps 1620 in the embodiment of FIG. 16 each tap one of the four LO signals.

The tap 1620 siphons a small portion of the optical signal intensity while passing the rest to the receiver 125. A tap receiver 1630 coupled to each tap 1620 may receive the optical signal siphoned by the tap 1620 and output a voltage coupled to an LED 1640. The tap receiver 1630 may include a photodetector to convert the optical signal from the tap 1620 to electrical current. The tap receiver 1630 may additionally include a resistor, or one or more operational amplifiers acting as a transimpedance amplifier, to convert the current to a voltage.

The LED 1640 may be selected such that a minimum voltage required to operate the LED 1640 is sufficient to indicate proper operation. That is, if both light sources 115A1 and 115B1 operated at the same wavelength, then the tap 1620 output (light intensity) to the tap receiver 1630 may be insufficient (e.g., below a threshold value) to operate the LED 1640, thereby indicating a mismatch in wavelengths when the LED 1640 is not emitting light during operation. In alternate embodiments, an inverter may be used to reverse the indication (e.g., tap 1620 output to the tap receiver 1630 is above a threshold value) such that the LED 1640 emission may indicate insufficient signal (i.e., mismatched wavelengths) rather than sufficient signal and proper operation. The indicator LEDs 1640 may be used by an operator to identify whether or not an optical cable has been installed in a compatible port and take corrective action as needed, for example.

While FIG. 16 is an exemplary embodiment including local modulation, the discussion regarding complementary operation and the LEDs 1640 applies, as well, to remote or hybrid systems. As previously noted, WDMs 410 may require asymmetric transceivers 110 for proper operation. Thus, any of the embodiments (e.g., those shown in FIGS. 4-6 and 10-12) with WDMs 410 used to combine and split modulated and unmodulated signals may include LEDs 1640 or other indicators to ensure that an asymmetric pair of transceivers 110 is being used.

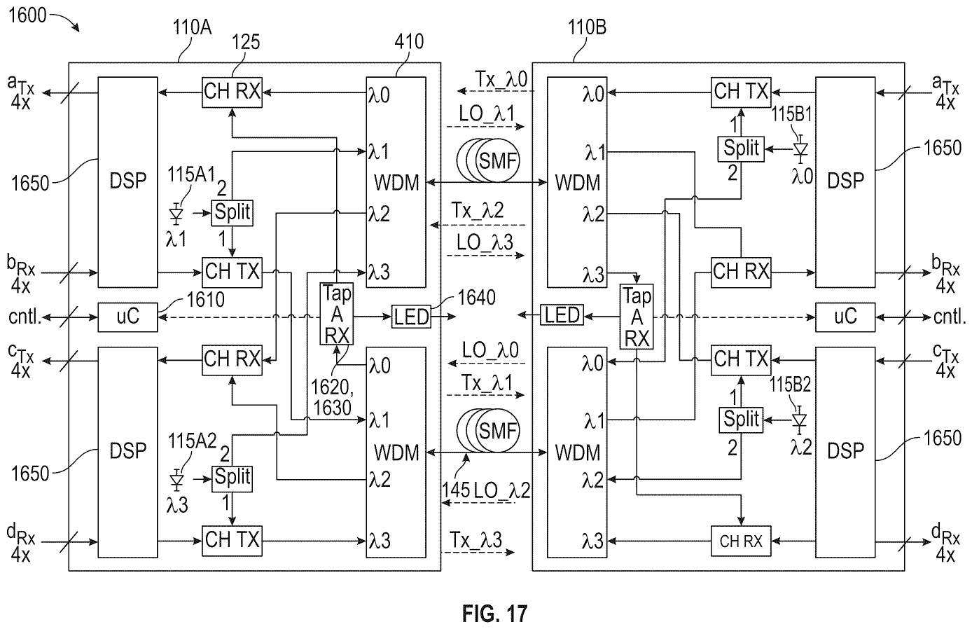

FIG. 17 is a block diagram of an exemplary multi-wavelength optical communication system 1600 according to some embodiments. As in FIG. 16, the exemplary embodiment pertains to local modulation. In addition, each instance of every component is not labeled for readability. Unlike the embodiment of FIG. 16, the wavelengths λ1 and λ3 associated with the light sources 115A1, 115A2 of the transceiver 110A are not the same as the wavelengths λ0 and λ2 associated with the light sources 115B1, 115B2 of the transceiver 110B.

The wavelengths λ1 and λ0 form one pair (i. e, a communication channel). That is, the LO signal and modulated signal at wavelength λ1 are provided to the receiver 125 associated with the light source 115B1, which is associated with wavelength λ0 and the LO signal and modulated signal at wavelength λ0 are provided to the receiver 125 associated with the light source 115A1, which is associated with wavelength λ1. Similarly, the wavelengths λ3 and λ2 form one pair (i. e, a communication channel). That is, the LO signal and modulated signal at wavelength λ3 are provided to the receiver 125 associated with the light source 115B2, which is associated with wavelength λ2 and the LO signal and modulated signal at wavelength λ2 are provided to the receiver 125 associated with the light source 115A2, which is associated with wavelength λ3.

The signals carried by each of the two optical fibers 145 is indicated. In the exemplary embodiment of FIG. 17, each transceiver 110 has one tap 1620, tap receiver 1630, and LED 1640. Because the wavelengths associated with each of the transceivers 110 are different, monitoring each communication channel at one transceiver 110 (e.g., wavelength of LO_λ0 at transceiver 110A and wavelength of LO_ λ3 at transceiver 110B, as shown) can verify asymmetry of the transceivers 110.

The tap 1620 of transceiver 110A is coupled to the WDM 410 output of the LO signal at wavelength λ0, and the tap 1620 of transceiver 110B is coupled to the WDM 410 output of the LO signal at wavelength λ3. According to an exemplary embodiment, the operation of the LEDs 1640 may indicate sufficient intensity of a signal at the corresponding wavelength, as discussed with reference to FIG. 16. That is, for example, at transceiver 110A, the tap 1620 may siphon some of the signal intensity for the LO signal at wavelength λ0 and the tap receiver 1630 may use the siphoned signal to power the LED 1640 of transceiver 110A to emit light when the LO signal at wavelength λ0 is sufficient (i.e., when the communication channel associated with wavelength pair λ1 and λ0 is operational). Similarly, the LED 1640 of transceiver 110B may be powered on when the LO signal at wavelength λ3 is sufficient (i.e., when the communication channel associated with wavelength pair λ3 and λ2 is operational).

As indicated in FIG. 17, each tap 1620 and/or tap receiver 1630 is coupled to the microcontroller 1610 of the same transceiver 110. Thus, according to additional or alternate embodiments, the microcontroller 1610 of transceiver 110A may be notified of the operational state of the communication channel associated with wavelength pair λ1 and λ0, and the microcontroller 1610 of transceiver 110B may be notified of the operational state of the communication channel associated with wavelength pair λ3 and λ2. The microcontrollers 1610 may communicate the operational states to the servers or network switches to which each of the microcontrollers 1610 is coupled, for example. The microcontrollers 1610 may also use the tap receiver 1630 outputs and any additional signals or processing to control the LEDs 1640.

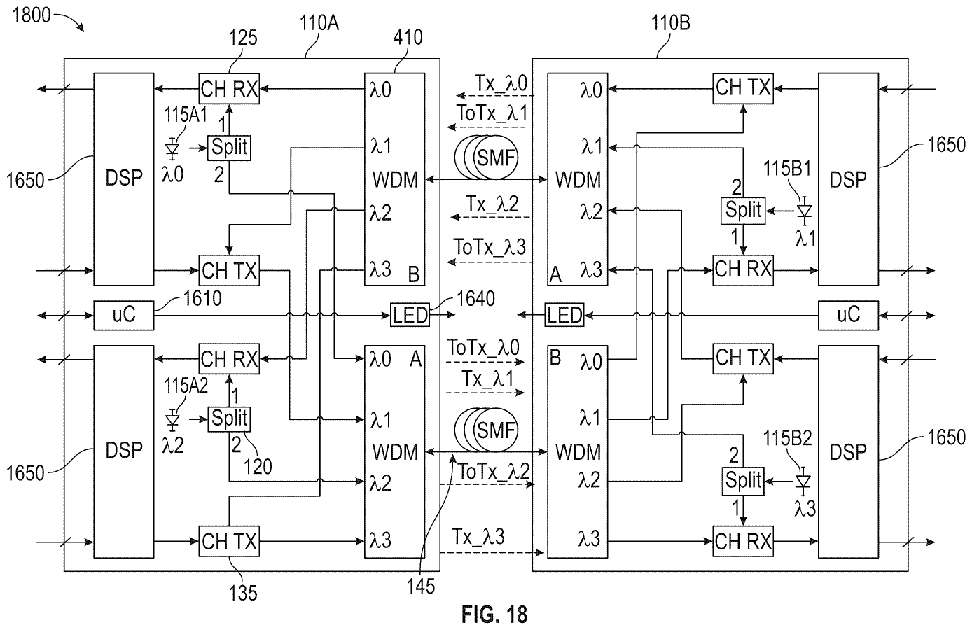

FIG. 18 is a block diagram of an exemplary multi-wavelength optical communication system 1800 according to some embodiments. Each instance of a component is not labeled for readability. The exemplary optical communication system 1800 in FIG. 18 performs remote modulation, as indicated by the fact that each splitter 120 coupled to each light source 115 provides one light beam to a receiver 125 of the same transceiver 110 as the light source 115 as an LO signal and provides the other light beam to a WDM 410 to be sent to the other transceiver 110 for (remote) modulation by a transmitter 135 of the other transceiver 110. Thus, an LO signal is not sent via fiber cable 145 from a light source 115 of one transceiver 110 to a receiver 125 of a different transceiver 110. Instead, a (remotely) modulated signal (indicated as “Tx”) or an unmodulated signal to be (remotely) modulated (indicated as “ToTx”) is conveyed via fiber cable 145. The signals conveyed via the two fiber cables 145 are indicated.

The light beam split from the light source 115A1 (at wavelength λ0) is sent as ToTx_ λ0 and is modulated by the transmitter associated with the light source 115B1 (at wavelength λ1). The light beam split from the light source 115B1 (at wavelength λ1) is sent as ToTx_ λ1 and is modulated by the transmitter associated with the light source 115A1 (at wavelength λ0). Thus, the wavelength pair λ0 and λ1 makes up one communication channel. Similarly, the light beam split from the light source 115A2 (at wavelength λ2) is sent as ToTx_ λ2 and is modulated by the transmitter associated with the light source 115B2 (at wavelength λ3). The light beam split from the light source 115B2 (at wavelength λ3) is sent as ToTx_ λ3 and is modulated by the transmitter associated with the light source 115A2 (at wavelength λ2). Thus, the wavelength pair λ2 and λ3 makes up one communication channel.

The exemplary embodiment of FIG. 18 does not include any taps 1620. Instead, one LED 1640 for each transceiver 110 is shown coupled to a microcontroller 1610. Thus, the microcontroller 1610 may control operation of the corresponding LED 1640 to monitor for asymmetry among the transceivers 110 and indicate which communication channel is operational at a given time. For example, the microcontroller 1610 of transceiver 110A may control the LED 1640 of transceiver 110A to emit light when the communication channel associated with wavelength pair λ0 and λ1 is operational, and the microcontroller 1610 of transceiver 110B may control the LED 1640 of transceiver 110B to emit light when the communication channel associated with wavelength pair λ2 and λ3 is operational.

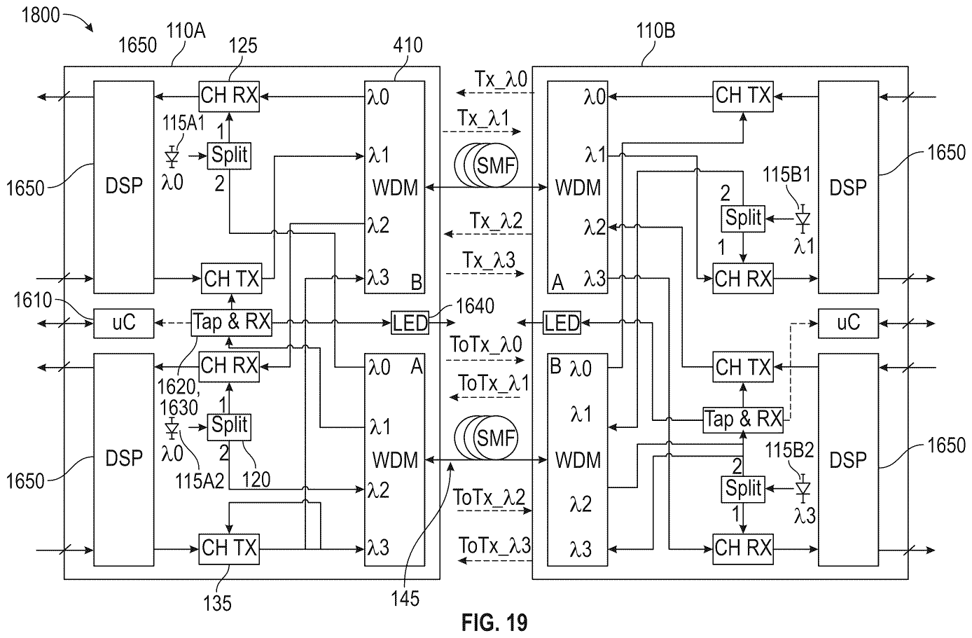

FIG. 19 is a block diagram of an exemplary multi-wavelength optical communication system 1800 according to some embodiments. As in FIG. 18, each instance of a component is not labeled for readability, and the exemplary optical communication system 1800 performs remote modulation. The wavelength pair λ0 and λ1 represents one communication channel and the wavelength pair λ2 and λ3 represents another communication channel. Unlike the exemplary embodiment shown in FIG. 18, the embodiment of FIG. 19 includes a tap 1620 and tap receiver 1630 at each transceiver 110 that is coupled to an LED 1640 and a microcontroller 1610. The tap 1620 of transceiver 110A obtains the unmodulated signal at wavelength λ1 (indicated as ToTx_ λ1) to monitor asymmetry of one of the communication channels, and the tap 1620 of transceiver 110B obtains the unmodulated signal at wavelength λ2 (indicated as ToTx_ λ2) to monitory asymmetry of the other communication channel.

Thus, as discussed with reference to FIGS. 16 and 18, the tap 1620 of transceiver 110A may be used to determine if the communication channel associated with the wavelength pair λ0 and λ1 is operational, and the tap 1620 of transceiver 110B may be used to determine if the communication channel associated with the wavelength pair λ2 and λ3 is operational. In addition to controlling the corresponding LED 1640 based on the tap 1620 input, a signal may be provided to the microcontroller 1610. The microcontroller 1610 may communicate the operational information to the server or network switch coupled to the transceiver, for example.

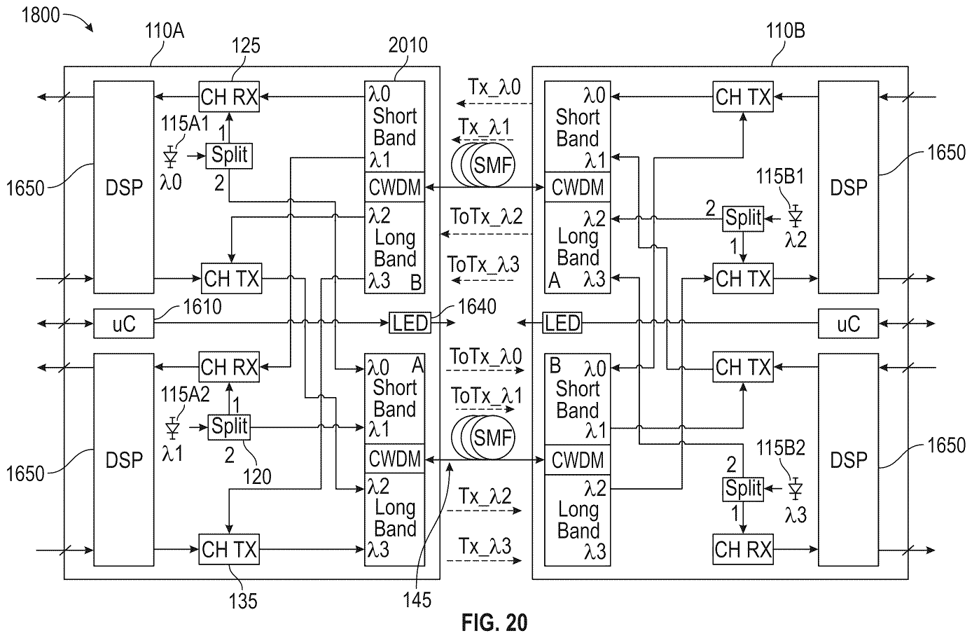

FIG. 20 is a block diagram of an exemplary multi-wavelength optical communication system 1800 according to some embodiments. As in FIGS. 18 and 19, each instance of a component is not labeled for readability, and the exemplary optical communication system 1800 performs remote modulation. The wavelength pair λ0 and λ2 represents one communication channel and the wavelength pair λ1 and λ3 represents another communication channel. Unlike the exemplary embodiments shown in FIGS. 18 and 19, the exemplary embodiment of FIG. 20 includes coarse wavelength division multiplexors 2010 rather than WDMs 410 but may also require asymmetry among the transceivers 110 and, thus, may include the LEDs 1640 according to the exemplary embodiment.

The CWDMs 2010 may take advantage of wider spacing among the wavelengths conveyed over the fiber cables 145, including wavelengths in different bands (e.g., 1310 nm and 1550 nm). As indicated in FIG. 20 as an example, wavelengths λ0 and λ1 may be short band wavelengths and wavelengths λ2 and λ3 may be long band wavelengths. Thus, each wavelength pair (λ0 and λ2 and λ1 and λ3) includes wavelengths from different bands.

Like the exemplary embodiment discussed with reference to FIG. 18, the embodiment of FIG. 20 includes a microcontroller 1610 coupled to an LED 1640 at each transceiver 110. Thus, the microcontrollers 1610 of the two transceivers 110 may control corresponding LEDs 1640 to indicate operation of different communication channels (e.g., the LED 1640 of transceiver 110A indicates operation of the communication channel associated with wavelength pair λ0 and λ2 and the LED 1640 of transceiver 110B indicates operation of the communication channel associated with wavelength pair λ1 and λ3).

While exemplary embodiments have been discussed with reference to FIGS. 16-20 for explanatory purposes, variations and combinations are contemplated and are not intended to be limited by the examples. For example, while local modulation multi-wavelength optical communication systems 1600 and remote modulation multi-wavelength optical communication systems 1800 have been discussed, the channel mismatch indication or operational communication channel indication may be used with hybrid multi-wavelength optical communication systems in some embodiments. Additionally, any number of LEDs 1640 may be used to indicate different operations of the multi-wavelength optical communication systems 1600, 1800, or additional (e.g., hybrid) embodiments.

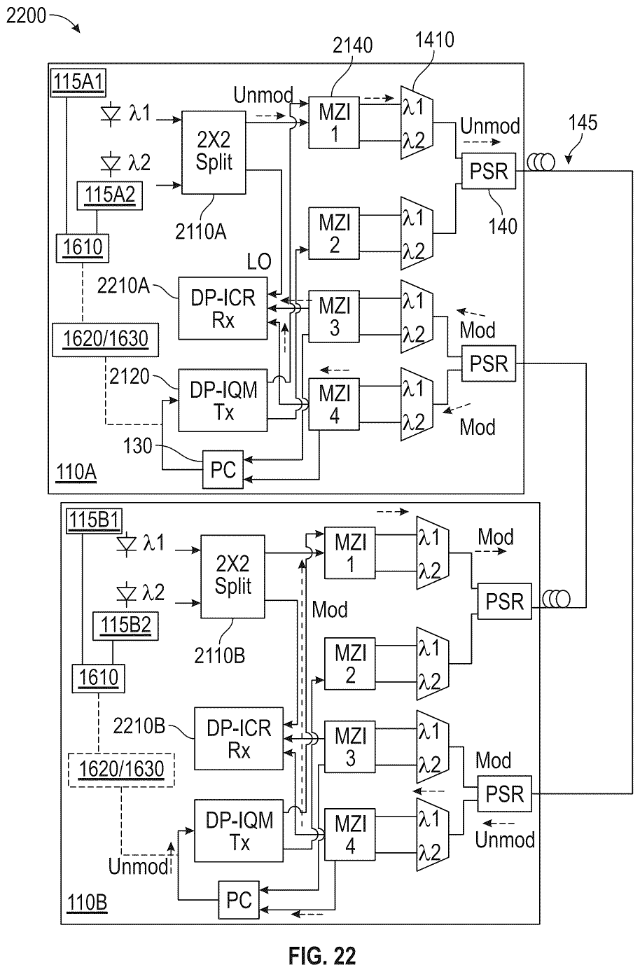

FIG. 21 is a block diagram of an exemplary dual-wavelength optical communication system 2100 according to some embodiments. Every instance of the same component is not labeled for readability. The exemplary embodiments shown in FIGS. 21 and 22 facilitate dual or multi-wavelength operation without requiring asymmetric transceivers 110, as WDMs 410 or CWDMs 2010 may require, for example. Using identically assembled transceivers 110 may simplify implementation and reduce a potential for non-complementary transceivers 110 being coupled. At the same time, the Mach Zender interferometers (MZI) 2140 used in the exemplary embodiments of FIGS. 21 and 22 may require monitoring of the wavelengths to ensure proper operation, as detailed.

The exemplary optical communication system 2100 implements dual-polarization and performs local modulation at each of the transceivers 110A, 110B. As illustrated in FIG. 21, the light source 115A1 (at transceiver 110A), operating at wavelength λ1, and the light source 115B2 (at transceiver 110B), operating at wavelength λ2, are on at the same time. At other times, the light source 115A2 (at transceiver 110A), operating at wavelength λ2, and the light source 115B1 (at transceiver 110B0, operating at wavelength λ1, may be on at the same time. This ensures complementary operation required by the MZIs 2140.

As discussed for the exemplary embodiment shown in FIG. 16, LEDs 1640 may be used to provide an indication of complementary or improper operation. Additionally or alternately, as shown in FIG. 21, a microcontroller 1610, switch controller, or other selector at each transceiver 110 may determine which of the two light sources (115A1 or 115A2 of transceiver 110A and 115B2 or 115B1 of transceiver 110B) should be operational at a given time for proper operation and how the switches of the MZIs 2140 should be set based on the operational wavelengths.

The control by the microcontrollers 1610 is detailed by way of a signal path from light source 115A1 shown in FIG. 21. A two-input two-output (2×2) splitter 2110A of transceiver 110A is used to split the incoming light from light source 115A1, the only operational light source 115 of the transceiver 110A according to the illustrated period in FIG. 21. One of the resulting light beams may be provided to the transmitter, a dual-polarization in-phase and quadrature modulator (DP-IQM) 2120A, which may perform (local) modulation based on data provided by a device (e.g., server or network switch) coupled to the transceiver 110A. The DP-IQM 2120A may output a modulated signal (indicated as sig) to the MZI 2140 indicated as MZI 1.

Each MZI 2140 is a two-port bidirectional optical switch that can be configured to define which input(s) connect to which output(s). Thus, based on which of the light sources (e.g., 115A1 or 115A2) is operational, the MZIs 2140 may be controlled to route the signals with the wavelength associated with the operational light source 115 (i.e., left to right routing according to the exemplary arrangement shown in FIG. 20), as well as to route the incoming signals (with a complementary rather than same wavelength) from the transceiver 110B (i.e., right to left routing according to the exemplary arrangement shown in FIG. 20).

The modulated signal (sig) may be passed through a multiplexer 1410 to a PSR 140, as shown by the dashed line. The transmitter being DP-IQM 2120 means that the modulated signal is in two parts with different polarizations. The other light beam output by the 2×2 splitter 2110 may be provided as an LO signal (indicated as LO) that facilitates demodulation of the modulated signal (sig) at the other transceiver 110B. The LO signal may be routed to an MZI 2140 (indicated as MZI 4) and may be passed through a multiplexer 1410 to another PSR 140 of the transceiver 110A, as shown by the dashes and dots.

At the transceiver 110B, the LO signal from the transceiver 110A may be routed by a PSR 140 to two multiplexers 1410 and to two MZIs 2140 (indicated as MZI 1 and MZI 2). As shown, MZI 1 provides the LO signal to a receiver, an integrated coherent receiver (ICR) 2130B1, used for a first part of the modulated signal (sig) from the transceiver 110A with a first polarization (indicated as X). As also shown, MZI 2 provides the LO signal to a receiver, ICR 2130B2, used for a second part of the modulated signal (sig) from the transceiver 110A with a second polarization (indicated as Y).

Also at the transceiver 110B, the modulated signal (sig) from the transceiver 110A may be routed by a different PSR 140 to a PC 130 that may direct the different parts of the modulated signal (with polarizations indicated as X and Y) to different multiplexers 1410, as shown. The modulated signal with polarization indicated as X is routed through MZI 3 of the transceiver 110B to the corresponding receiver, ICR 2130B1 indicated as X-ICR, and the modulated signal with polarization indicated as Y is routed through MZI 4 of the transceiver 110B to the corresponding receiver, ICR 2130B2, indicated as Y-ICR. Each of the ICRs 2130B1, 2130B2 may provide a demodulated signal to a device coupled to the transceiver 110B.

The LO signal from the transceiver 110A may be directed through the fiber cable 145 to transceiver 110B at the same time that a (locally) modulated signal from DP-IQM 2120B is conveyed from the transceiver 110B to the transceiver 110A in the same fiber cable 145. Thus, for the MZIs 2140 at each of the transceivers 110 to operate properly, the wavelengths associated with each of the transceivers 110 at a given time may be different (i.e., complementary).

Complementary operation may be controlled according to a number of different embodiments according to examples and combinations discussed with reference to different figures and according to known monitoring and communication techniques. For example, the microcontrollers 1610 of the two transceivers 1610 may communicate with each other, directly or via devices to which they are respectively coupled, to determine which wavelength should be used by each transceiver 110. The devices to which the transceivers 110 are coupled may communicate and signal each microcontroller 1610 to use a specific wavelength.

According to other embodiments, communication may not be needed for the complementary operation. For example, one or more taps 1620 may be used between the fiber cable 145 and one or both ICRs 2130 at each transceiver 110. Based on the intensity of the tapped modulated signal, it may be determined (e.g., by one or both microcontrollers 1610) that the transceivers 110 are operating at the same wavelength. In this case, one or both microcontrollers 1610 may or may not control the light sources 115 of the corresponding transceiver 110 to change the wavelength (i.e., turn off the light source 115 in use and turn on the other light source 115). The determination of whether or not to change the wavelength may be randomly controlled. This process (of randomly changing or not changing the operational wavelength at each transceiver 110) may be repeated until the wavelengths are complementary. Whenever a microcontroller 1610 of either of the transceivers 110 controls a change in which of the light sources 115 is operational, the microcontroller 1610 may implement a corresponding change in the switches of the MZIs 2140 of the same transceiver 110.

FIG. 22 is a block diagram of an exemplary dual-wavelength optical communication system 2200 according to some embodiments. Every instance of the same component is not labeled for readability. The exemplary optical communication system 2200 of FIG. 22 performs remote modulation. A dashed line is used to indicate the path of an unmodulated signal (indicated as unmod) from transceiver 110A to the DP-IQM 2120 of transceiver 110B, where it is used to generate a dual-polarization (remotely) modulated signal (indicated as mod). The modulated signal is returned to the transceiver 110A. The exemplary optical communication system 2200 of FIG. 22 is shown with a dual-polarization integrated coherent receiver (DP-ICR) 2210 for each transceiver 110 rather than two ICRs 2230 per transceiver 110 as in the example shown in FIG. 21. Thus, both parts of the modulated signal (mod), each with a different polarization, are routed to the DP-ICR 2210 for demodulation. In the exemplary embodiment of FIG. 22, an exemplary routing path through MZI 4 of the transceiver 110B, based on the switch settings of the MZI 2140, is indicated.

As discussed with reference to FIG. 21, a microcontroller 1610, switch controller, or other selector at each transceiver 110 may determine which of the two light sources (115A1 or 115A2 of transceiver 110A and 115B2 or 115B1 of transceiver 110B) should be operational at a given time for proper (complementary) operation and may control switches of associated MZIs 2140 to correspond to the selected wavelength. The microcontrollers 1610 of the transceivers 110 that are coupled via one or more fiber cables 145 may communicate with each other, directly or indirectly, or may monitor one or more signals received via the fiber cable(s) 145 to control the light sources 115.

According to an exemplary embodiment, an optional tap 1620 and tap receiver 1630 are shown coupled to one of the signals (unmodulated (unmod) signal received from the other transceiver 110) and to the microcontroller 1610 at each transceiver 110. The exemplary illustration indicates one approach that may be employed to monitor the wavelength of an incoming signal (from the other transceiver 110). For example, if the microcontroller 1610 at transceiver 110A determines that the monitored signal is at wavelength λ1 and knows that it has controlled the light sources 115 of the transceiver 110A such that light source 115A1 associated with wavelength λ1 is operational, then the microcontroller 1610 of the transceiver 110A may determine that communication is not complementary.

Similarly, the microcontroller 1610 at transceiver 110B may make the same determination. In this case, each microcontroller 1610 may make a randomly generated decision to either change which light source 115 is operational or not. Over one or more iterations of this process, complementary operation may be achieved between the transceivers 110A, 110B. As noted with reference to FIG. 21, any change to the operational state of the light sources 115 at a given transceiver 110 may be accompanied by a change in switches of the associated MZIs 2140 (of that transceiver 110) to ensure proper operation.

According to another exemplary embodiment, a combination of communication and monitoring may be employed. For example, the microcontrollers 1610 may communicate, directly or indirectly, to determine which of them will monitor a received signal wavelength and switch the light sources 115 (and MZIs 2140) as needed. This approach may avoid multiple iterations to randomly achieve complementary operation.

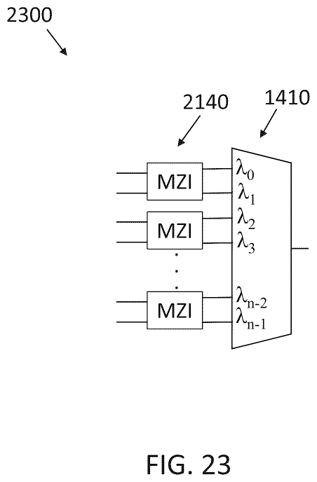

While FIGS. 21 and 22 illustrate the complementary wavelength control for local modulation and remote modulation schemes, respectively, it should be understood that the wavelength control may be applied, as well, to a hybrid system. Further, as discussed with reference to FIG. 23, the exemplary embodiments of FIGS. 21 and 22 may be extended to more than one complementary pair of wavelengths.

FIG. 23 is a block diagram of aspects of a multi-wavelength pair optical communication system 2300, according to some embodiments, that may be used to extend dual-wavelength systems such as those shown in FIGS. 21 and 22, for example. A total of n wavelengths are shown in n/2 pairs. A combination of n/2 MZIs 2140 and a multiplexer 1410 may be used for each MZI 2140 and multiplexer 1410 shown in FIGS. 21 and 22. Similarly, n/2 DP-ICRs 2210, DP-IQMs 2120, and PCs 130 may be needed.

At a given time, only one light source 115 of each pair may be operational at each transceiver 110 but, based on demultiplexers 1415 being used, more than one pair may be operational at a given time (e.g., wavelengths λ1, λ2, and λn−1 may be in use together but not wavelengths λ1, λ2, λ3, and λn−1 or λ0 and λ1). In addition, complementary operation among the two transceivers 110 may be required. For example, a light source 115 associated with wavelength λn−2 may be operated at transceiver 110A when a light source 115 associated with wavelength λn−1 is operated at transceiver 110B. As another example, by additionally using demultiplexers 1415, light sources 115 associated with wavelengths λ3 and λn−2 may be operated at transceiver 110A when light sources 115 associated with wavelengths λ2 and λn−1 may be operated at transceiver 110B.

Although explanatory embodiments have been described, other embodiments are possible. Therefore, the spirit and scope of the claims should not be limited to the description of the exemplary embodiments. Various modifications, variations, and combinations can be made without departing from the scope and principle of the present disclosure.

What is claimed is:

1. An optical communication system comprising:
a first optical transceiver comprising:
a receiver;
a light source configured to output a light signal;
a splitter configured to split the light signal to a first signal and a second signal, wherein the first signal is provided to the receiver as a local oscillator;
a second optical transceiver including a transmitter configured to obtain the second signal from the first optical transceiver and modulate the second signal to generate a modulated signal that is provided to the receiver of the first optical transceiver, wherein the receiver of the first optical transceiver demodulates the modulated signal based on the local oscillator.

2. The optical communication system of claim 1, wherein the first optical transceiver includes a transmitter configured to modulate an unmodulated signal generated at the second optical transceiver and provided to the first optical transceiver.

3. The optical communication system of claim 2, wherein the second optical transceiver includes a receiver configured to demodulate a modulation output of the transmitter of the first optical transceiver that is provided to the second optical transceiver.

4. The optical communication system of claim 2, wherein the second optical transceiver includes a light source configured to output a light signal, and the light source of the first optical transceiver outputs the light signal at a different wavelength than a wavelength of the light signal output by the light source of the second optical transceiver.

5. The optical communication system according to claim 1, wherein the second optical transceiver also includes a semiconductor optical amplifier arranged to amplify the second signal prior to modulation by the transmitter of the second optical transceiver.

6. The optical communication system according to claim 1, wherein the second optical transceiver also includes a semiconductor optical amplifier arranged to amplify the modulated signal following modulation by the transmitter of the second optical transceiver prior to the modulated signal being provided to the first optical transceiver.

7. The optical communication system according to claim 1, wherein the first optical transceiver also includes a semiconductor optical amplifier arranged to amplify the modulated signal prior to demodulation by the receiver of the first optical transceiver.

8. The optical communication system according to claim 1, wherein the first optical transceiver or the second optical transceiver includes one or more amplifiers.

9. The optical communication system according to claim 1, wherein the first optical transceiver includes a transmitter and both the transmitter of the first optical transceiver and the transmitter of the second optical transceiver modulate signals generated by the light source of the first optical transceiver.

10. The optical communication system according to claim 1, wherein the transmitter implements dual-polarization modulation such that the modulated signal includes a first modulated signal with a first polarization and a second modulated signal with a second polarization.

11. An optical communication system comprising:
a first optical transceiver comprising:
a first receiver,
a first transmitter, and
a light source configured to output a light signal;
a second optical transceiver comprising:
a second receiver, and
a second transmitter, wherein both the first transmitter of the first optical transceiver and the second transmitter of the second optical transceiver modulate signals generated by the light source of the first optical transceiver.

12. The optical communication system of claim 11, wherein the first receiver receives a modulated signal generated by the second transmitter.

13. The optical communication system of claim 12, wherein the second receiver receives a modulated signal generated by the first transmitter.

14. The optical communication system according to claim 11, wherein the first optical transceiver includes one or more additional light sources in addition to the light source.

15. The optical communication system according to claim 14, wherein each of the one or more additional light sources is configured to output a light signal at a different wavelength than signals output by the light source or others of the one or more additional light sources.

16. An optical communication system comprising:
a first optical transceiver comprising:
a first receiver,
a first transmitter,
a first light source configured to output a first light signal at a first wavelength,
a first fiber optic tap, and
a first light emitting diode (LED), wherein
the first fiber optic tap is configured to siphon a portion of an input signal, received via a fiber cable, at the first optical transceiver, and
the first LED is configured to emit light based on the portion of the input signal having an intensity above or below a threshold value.

17. The optical communication system of claim 16, further comprising:
a second optical transceiver comprising:
a second receiver,
a second transmitter, and
a second light source configured to output a second light signal at a second wavelength, wherein the input signal, received via the fiber cable at the first optical transceiver, is provided at the second wavelength from the second optical transceiver and the first LED is configured to indicate whether the first wavelength and the second wavelength are a same wavelength or a different wavelength.

18. The optical communication system of claim 17, wherein
the first optical transceiver further comprises:
a third receiver,
a third transmitter, and
a third light source configured to output a third light signal at a third wavelength; and
the second optical transceiver further comprises:
a fourth receiver,
a fourth transmitter,
a fourth light source configured to output a fourth light signal at a fourth wavelength,
a second fiber optic tap, and
a second light emitting diode (LED), wherein
the second fiber optic tap is configured to siphon a portion of a second input signal, received via a second fiber cable, at the second optical transceiver, and
the second LED is configured to emit light based on the portion of the second input signal having an intensity above or below a second threshold value.

19. The optical communication system of claim 18, wherein the second input signal, received via the second fiber cable at the second optical transceiver, is provided at the third wavelength from the first optical transceiver and the second LED is configured to indicate whether the third light source and the fourth light source are in use.

20. The optical communication system of claim 16, wherein the first optical transceiver further comprises a microcontroller configured to control the first LED based on the portion of the input signal.

21. An optical communication system comprising:
a first optical transceiver comprising:
a first light source configured to emit a light signal at a first wavelength,
a second light source configured to emit a light signal at a second wavelength, and
a first controller configured to control only one of the first light source and the second light source to be operational at a time;
a second optical transceiver comprising:
a third light source configured to emit a light signal at the first wavelength,
a fourth light source configured to emit a light signal at the second wavelength, and
a second controller configured to control only one of the third light source and the fourth light source to be operational at a time, wherein
the first controller is configured to control the first light source and the second light source and the second controller is configured to control the third light source and the fourth light source, respectively, such that the first light source and the third light source are not operational at a same time and the second light source and the fourth light source are not operational at a same time.

22. The optical communication system of claim 21, wherein the first controller and the second controller are configured to communicate with each other to control the first light source, the second light source, the third light source, and the fourth light source.

23. The optical communication system of claim 21, wherein the first controller is configured to monitor a wavelength of an input signal received from the second optical transceiver.

24. The optical communication system of claim 23, wherein the first controller is configured to control the first light source and the second light source based on whether the wavelength of the input signal is the first wavelength or the second wavelength.

25. The optical communication system of claim 23, wherein
the second controller is configured to monitor a second wavelength of a second input signal received from the first optical transceiver, and
the first controller and the second controller are configured to randomly control the first light source and the second light source and the third light source and the fourth light source, respectively, based on the wavelength of the input signal and the second wavelength of the second input signal being a same wavelength.

26. The optical communication system of claim 21, wherein:
the first optical transceiver further comprises one or more Mach Zender interferometers (MZIs), and
the first controller is further configured to control switches of the one or more MZIs to correspond with the first wavelength or the second wavelength based on which of the first light source or the second light source is controlled to be operational at the time.
